(19) United States
(12) Patent Application Publication
(10) Pub. No.: US 2023/0111478 A1
(43) Pub. Date: Apr. 13, 2023

(54) OPTICAL FIBER CABLE FOR FEED-LIGHT TRANSMISSION AND POWER-OVER-FIBER SYSTEM

(71) Applicant: KYOCERA CORPORATION, Kyoto-shi, Kyoto (JP)

(72) Inventor: Tomonori SUGIME, Yokohama-shi, Kanagawa (JP)

(21) Appl. No.: 17/906,191

(22) PCT Filed: Dec. 21, 2020
(86) PCT No.: PCT/JP2020/047602

§ 371 Date: Sep. 13, 2022

(30) Foreign Application Priority Data
Mar. 16, 2020 (JP) 2020-044888

(51) Int. Cl. H04B 10/80; G02B 6/02; G02B 6/42

(52) U.S. Cl. CPC H04B 10/807; G02B 6/02361; G02B 6/4296

(57) ABSTRACT

An optical fiber cable for feed-light transmission includes an optical fiber, a cable sheath, and a phosphor layer. The optical fiber includes a channel of feed light. The cable sheath is located at a periphery of the optical fiber and has a property of shielding the feed light. The phosphor layer is located between the optical fiber and the cable sheath and emits fluorescence upon receiving the feed light. The cable sheath has a property of allowing at least part of the fluorescence emitted by the phosphor layer upon receiving the feed light to pass therethrough.

### RELATED APPLICATIONS

The present application is a National Phase of International Application No. PCT/JP2020/047602 filed Dec. 21, 2020, which claims priority to Japanese Application No. 2020-044888, filed Mar. 16, 2020.

### TECHNICAL FIELD

The present disclosure relates to optical power supply.

### BACKGROUND ART

Recently, an optical power supply system has been studied that converts electric power into light (called feed light), transmits the feed light, converts the feed light into electric energy, and uses the electric energy as electric power.

PTL 1 discloses an optical communication device including an optical transmitter, an optical fiber, and an optical receiver. The optical transmitter transmits signal light modulated based on an electric signal and feed light for supplying electric power. The optical fiber includes a core, a first cladding surrounding the core, and a second cladding surrounding the first cladding. The core transmits the signal light. The first cladding has a refractive index lower than that of the core and transmits the feed light. The second cladding has a refractive index lower than that of the first cladding. The optical receiver operates with electric power obtained by converting the feed light transmitted through the first cladding of the optical fiber and converts the signal light transmitted through the core of the optical fiber into the electric signal.

### CITATION LIST

### Patent Literature

PTL 1: Japanese Unexamined Patent Application Publication No. 2010-135989

### SUMMARY OF INVENTION

### Technical Problem

In optical power supply, higher-energy light transmission is expected to be performed.

If feed light is high-energy laser light and a damage such as a disconnection occurs in an optical fiber for transmitting the feed light, the high-energy laser light leaks from the damaged portion and breaks a sheath (covering). Consequently, leakage of the laser light to the outside of an optical cable may occur.

To avoid leakage of the high-energy laser light to the outside, breaking of the sheath (covering) needs to be avoided.

If feed light in an ultraviolet band is used for performing high-energy light transmission, it is difficult to visually find the leaking portion caused by the damage of the optical fiber. Even if suspicion of the damage of the optical fiber can be detected based on a leakage loss, it is difficult to identify the damaged portion.

### Solution to Problem

In one aspect of the present disclosure, an optical fiber cable for feed-light transmission includes an optical fiber, a cable sheath, and a phosphor layer. The optical fiber includes a channel of feed light. The cable sheath is located at a periphery of the optical fiber and has a property of shielding the feed light. The phosphor layer is located between the optical fiber and the cable sheath and emits fluorescence upon receiving the feed light.

### Advantageous Effects of Invention

In the one aspect of the present disclosure, in the optical fiber cable for feed-light transmission, even if the high-energy feed light leaks to the outside of the optical fiber because of a damage of the optical fiber, loss and/or dispersion of energy occur(s) through dispersion across the wavelength due to fluorescence emission. Thus, breaking of the cable sheath can be prevented, and leakage of the high-energy light to the outside of the cable can be prevented.

### BRIEF DESCRIPTION OF DRAWINGS

FIG. 1 is a diagram illustrating a configuration of a power-over-fiber system according to a first embodiment of the present disclosure.

FIG. 2 is a diagram illustrating a configuration of a power-over-fiber system according to a second embodiment of the present disclosure.

FIG. 3 is a diagram illustrating the configuration of the power-over-fiber system according to the second embodiment of the present disclosure, and illustrates optical connectors, etc.

FIG. 4 is a diagram illustrating a configuration of a power-over-fiber system according to another embodiment of the present disclosure.

FIG. 5 is a cross-sectional view of an optical fiber cable for feed-light transmission according to one embodiment.

FIG. 6 is a cross-sectional view of the optical fiber cable for feed-light transmission according to the one embodiment.

FIG. 7 is a graph illustrating a spectrum of feed light and a spectrum of radiated light obtained by a phospher through conversion.

FIG. 8 is a cross-sectional view of an optical fiber cable for feed-light transmission according to another embodiment.

FIG. 9 is a cross-sectional view of the optical fiber cable for feed-light transmission according to the other embodiment.

### DESCRIPTION OF EMBODIMENTS

One embodiment of the present disclosure is described below with reference to the drawings.

### (1) Overview of System

### First Embodiment

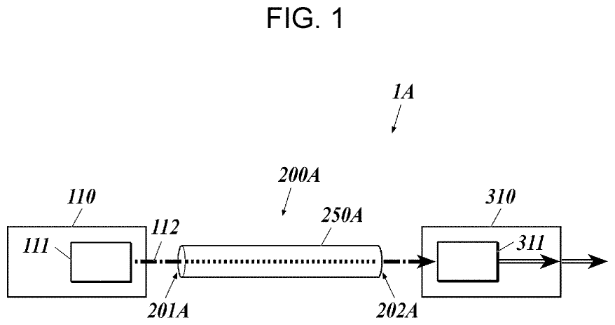

As illustrated in FIG. 1, a power-over-fiber (PoF) system 1A according to the present embodiment includes power sourcing equipment (PSE) 110, an optical fiber cable 200A, and a powered device (PD) 310.

In the present disclosure, the power sourcing equipment is equipment that converts electric power into optical energy and supplies the optical energy, and the powered device is a device that receives the supplied optical energy and converts the optical energy into electric power.

The power sourcing equipment 110 includes a semiconductor laser 111 for power supply.

The optical fiber cable 200A includes an optical fiber 250A that forms a channel of feed light.

The powered device 310 includes a photoelectric conversion element 311.

The power sourcing equipment 110 is connected to a power source, which electrically drives the semiconductor laser 111 for power supply and so on.

The semiconductor laser 111 for power supply oscillates with electric power supplied from the power source to output feed light 112.

The optical fiber cable 200A has one end 201A connectable to the power sourcing equipment 110 and an other end 202A connectable to the powered device 310, and transmits the feed light 112.

The feed light 112 from the power sourcing equipment 110 is input to the one end 201A of the optical fiber cable 200A. The feed light 112 propagates through the optical fiber 250A and is output from the other end 202A to the powered device 310.

The photoelectric conversion element 311 converts the feed light 112 transmitted through the optical fiber cable 200A into electric power. The electric power obtained by the photoelectric conversion element 311 through the conversion is used as driving electric power needed in the powered device 310. The powered device 310 is capable of outputting, for an external device, the electric power obtained by the photoelectric conversion element 311 through the conversion.

Semiconductor materials of semiconductor regions that exhibit a light-electricity conversion effect of the semiconductor laser 111 for power supply and the photoelectric conversion element 311 are semiconductors having a short laser wavelength of 500 nm or shorter.

Semiconductors having a short laser wavelength have a large band gap and a high photoelectric conversion efficiency. Thus, the photoelectric conversion efficiency on the power-generating side and the powered side of optical power supply improves, and consequently the optical power supply efficiency improves.

Therefore, the semiconductor materials to be used may be, for example, semiconductor materials that are laser media having a laser wavelength (fundamental wave) of 200 to 500 nm such as diamond, gallium oxide, aluminum nitride, and gallium nitride.

The semiconductor materials to be used may be semiconductors having a band gap of 2.4 eV or greater.

For example, semiconductor materials that are laser media having a band gap of 2.4 to 6.2 eV such as diamond, gallium oxide, aluminum nitride, and gallium nitride may be used.

Laser light having a longer wavelength tends to have a higher transmission efficiency. Laser light having a shorter wavelength tends to have a higher photoelectric conversion efficiency. Thus, in the case of long-distance transmission, a semiconductor material that is a laser medium having a laser wavelength (fundamental wave) longer than 500 nm may be used. When the photoelectric conversion efficiency is prioritized, a semiconductor material that is a laser medium having a laser wavelength (fundamental wave) shorter than 200 nm may be used.

These semiconductor materials may be used in either the semiconductor laser 111 for power supply or the photoelectric conversion element 311. The photoelectric conversion efficiency is improved on the power-sourcing side or the powered side, and consequently the optical power supply efficiency improves.

### Second Embodiment

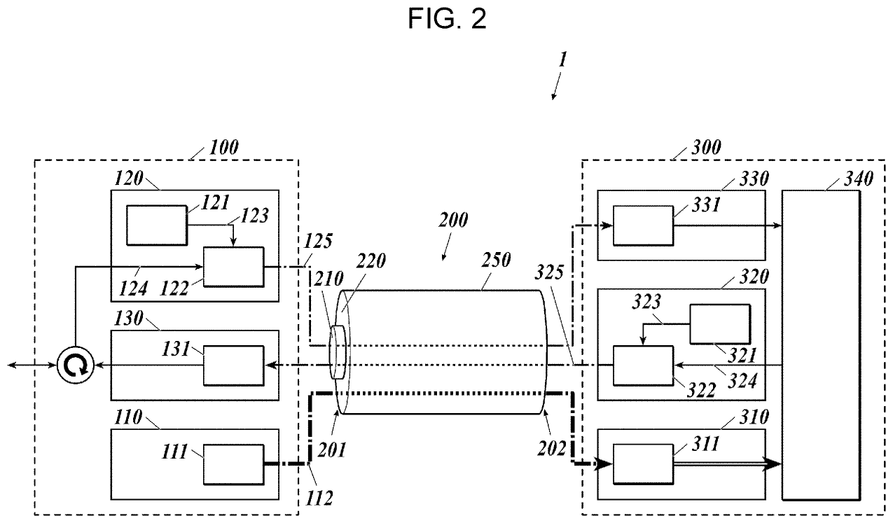

As illustrated in FIG. 2, a power-over-fiber (PoF) system 1 according to the present embodiment is a system including a power supply system and an optical communication system with an optical fiber. Specifically, the power-over-fiber system 1 includes a first data communication device 100 including power sourcing equipment (PSE) 110, an optical fiber cable 200, and a second data communication device 300 including a powered device (PD) 310.

The power sourcing equipment 110 includes a semiconductor laser 111 for power supply. The first data communication device 100 includes, in addition to the power sourcing equipment 110, a transmitter 120 and a receiver 130 that perform data communication. The first data communication device 100 corresponds to data terminal equipment (DTE), a repeater, or the like. The transmitter 120 includes a semiconductor laser 121 for signals and a modulator 122. The receiver 130 includes a photodiode 131 for signals.

The optical fiber cable 200 includes an optical fiber 250 including a core 210 and a cladding 220. The core 210 forms a channel of signal light. The cladding 220 is arranged to surround the core 210 and forms a channel of feed light.

The powered device 310 includes a photoelectric conversion element 311. The second data communication device 300 includes, in addition to the powered device 310, a transmitter 320, a receiver 330, and a data processor 340. The second data communication device 300 corresponds to a power end station or the like. The transmitter 320 includes a semiconductor laser 321 for signals and a modulator 322. The receiver 330 includes a photodiode 331 for signals. The data processor 340 is a unit that processes a received signal. The second data communication device 300 is a node in a communication network. Alternatively, the second data communication device 300 may be a node that communicates with another node.

The first data communication device 100 is connected to a power source, which electrically drives the semiconductor laser 111 for power supply, the semiconductor laser 121 for signals, the modulator 122, the photodiode 131 for signals, and so on. The first data communication device 100 is a node in the communication network. Alternatively, the first data communication device 100 may be a node that communicates with another node.

The semiconductor laser 111 for power supply oscillates with electric power supplied from the power source to output feed light 112.

The photoelectric conversion element 311 converts the feed light 112 transmitted through the optical fiber cable 200 into electric power. The electric power obtained by the photoelectric conversion element 311 through the conversion is used as driving electric power for the transmitter 320, the receiver 330, and the data processor 340 and as other driving electric power needed in the second data communication device 300. The second data communication device 300 may be capable of outputting, for an external device, the electric power obtained by the photoelectric conversion element 311 through the conversion.

On the other hand, the modulator 122 of the transmitter 120 modulates laser light 123 output from the semiconductor laser 121 for signals into signal light 125 on the basis of transmission data 124, and outputs the signal light 125.

The photodiode 331 for signals of the receiver 330 demodulates the signal light 125 transmitted through the optical fiber cable 200 into an electric signal, and outputs the electric signal to the data processor 340. The data processor 340 transmits data based on the electric signal to a node. The data processor 340 also receives data from the node, and outputs, as transmission data 324, the data to the modulator 322.

The modulator 322 of the transmitter 320 modulates laser light 323 output from the semiconductor laser 321 for signals into signal light 325 on the basis of the transmission data 324, and outputs the signal light 325.

The photodiode 131 for signals of the receiver 130 demodulates the signal light 325 transmitted through the optical fiber cable 200 into an electric signal, and outputs the electric signal. Data based on the electric signal is transmitted to a node. On the other hand, data from the node is treated as the transmission data 124.

The feed light 112 and the signal light 125 output from the first data communication device 100 are input to one end 201 of the optical fiber cable 200. The feed light 112 and the signal light 125 propagate through the cladding 220 and the core 210, respectively, and are output from an other end 202 of the optical fiber cable 200 to the second data communication device 300.

The signal light 325 output from the second data communication device 300 is input to the other end 202 of the optical fiber cable 200, propagates through the core 210, and is output from the one end 201 of the optical fiber cable 200 to the first data communication device 100.

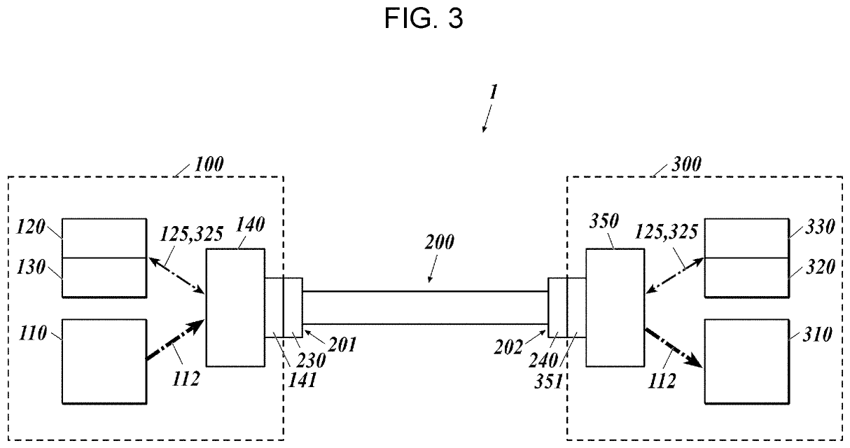

As illustrated in FIG. 3, the first data communication device 100 includes a light input/output part 140 and an optical connector 141 attached to the light input/output part 140. The second data communication device 300 includes a light input/output part 350 and an optical connector 351 attached to the light input/output part 350. An optical connector 230 at the one end 201 of the optical fiber cable 200 is connected to the optical connector 141. An optical connector 240 at the other end 202 of the optical fiber cable 200 is connected to the optical connector 351. The light input/output part 140 guides the feed light 112 to the cladding 220, guides the signal light 125 to the core 210, and guides the signal light 325 to the receiver 130. The light input/output part 350 guides the feed light 112 to the powered device 310, guides the signal light 125 to the receiver 330, and guides the signal light 325 to the core 210.

As described above, the optical fiber cable 200 has the one end 201 connectable to the first data communication device 100 and the other end 202 connectable to the second data communication device 300, and transmits the feed light 112. In the present embodiment, the optical fiber cable 200 transmits the signal light 125 and the signal light 325 bidirectionally.

As semiconductor materials of semiconductor regions that exhibit a light-electricity conversion effect of the semiconductor laser 111 for power supply and the photoelectric conversion element 311, same and/or similar materials as those mentioned in the first embodiment may be used, so that a high optical power supply efficiency is implemented.

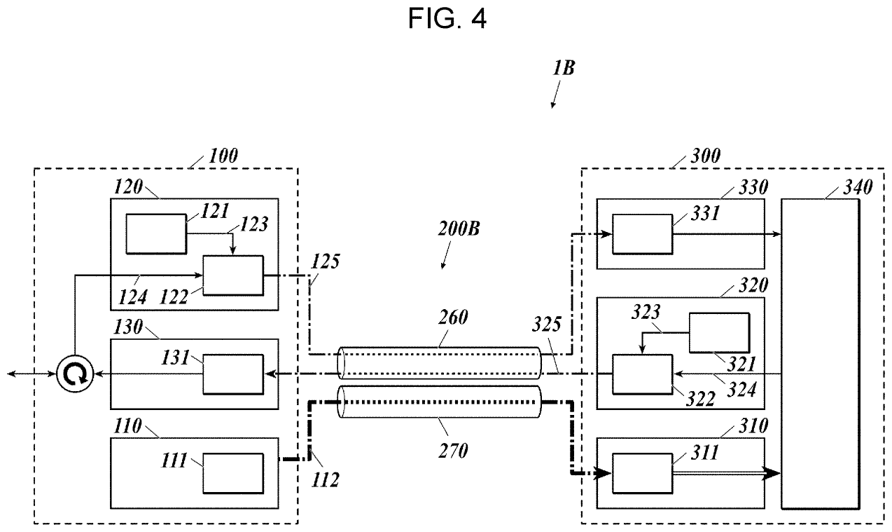

As in an optical fiber cable 200B of a power-over-fiber system 1B illustrated in FIG. 4, an optical fiber 260 that transmits signal light and an optical fiber 270 that transmits feed light may be provided separately. The optical fiber cable 200B may include a plurality of optical fiber cables.

(2) Optical Fiber Cable for Feed-Light Transmission Including phosphor

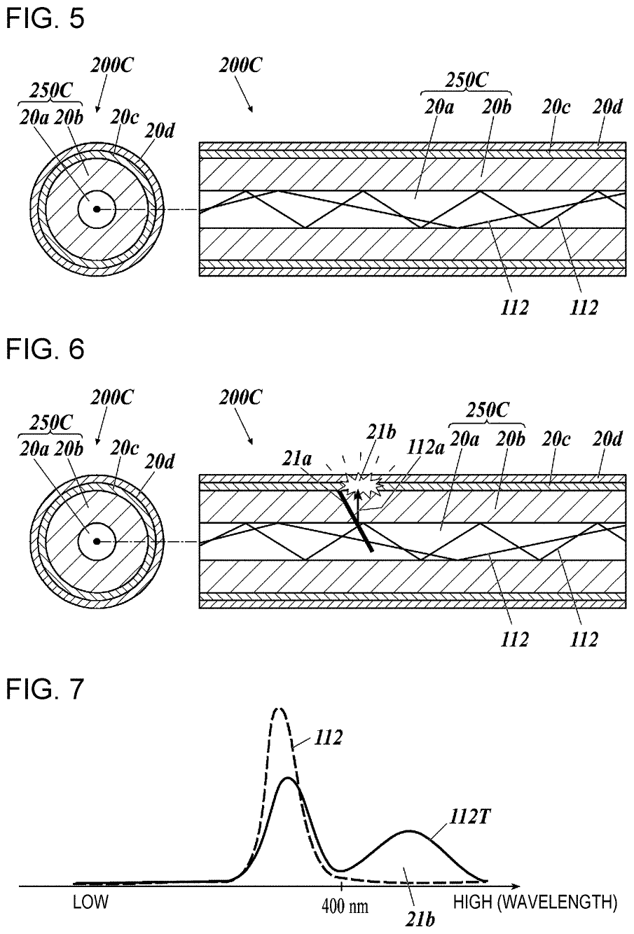

An optical fiber cable 200C for feed-light transmission including a phosphor layer 20C at a periphery portion as illustrated in FIG. 5 is used as the optical fiber cable 200A in the power-over-fiber system 1A described above, the optical fiber cable 200 in the power-over-fiber system 1 described above, or the optical fiber cable 200B in the power-over-fiber system 1B described above. FIG. 5 illustrates a structure in which the core 20a is a channel of the feed light 112 and is surrounded by the cladding 20b. The same and/or similar implementation is achieved when the channel of the feed light is the cladding 220 in the case illustrated in FIG. 2.

As illustrated in FIG. 5, the optical fiber cable 200C for feed-light transmission includes an optical fiber 250C. The optical fiber 250C includes the core 20a and the cladding 20b located at the periphery of the core 20a in contact with the core 20a. The optical fiber 250C includes the core 20a as the channel of the feed light 112.

The optical fiber cable 200C for feed-light transmission further includes a cable sheath 20d and the phosphor layer 20c. The cable sheath 20d is located at the periphery of the optical fiber 250C and has a property of shielding the feed light 112. The phosphor layer 20c is located between the optical fiber 250C and the cable sheath 20d and emits fluorescence upon receiving the feed light 112.

Suppose that a crack 21a is caused in the optical fiber 250C as illustrated in FIG. 6.

Suppose that feed light 112a partially leaks from the crack 21a.

The feed light 112a first reaches the phosphor layer 20c before leaking to the outside of the cable 200C.

At this time, the phospher layer 20c emits fluorescence 21b upon receiving the feed light 112a.

FIG. 7 illustrates a spectrum of the feed light 112 and a spectrum of radiated light 112T obtained by a phospher (20c) through conversion.

The feed light 112 used is ultraviolet light. The radiated light 112T includes the fluorescence 21b which is in a wavelength range not included in the feed light 112. The fluorescence 21b is visible light. The fluorescence 21b which is visible light spreads across a band wider than a band of the feed light 112 in a visible light range. The fluorescence 21b is, for example, white light.

The same wavelength component as that of the feed light 112 is at a low level in the radiated light 112T because of dispersion across the wavelength caused by the phospher layer 20c.

As described above, energy of the feed light 112 is dispersed across a wide wavelength range.

Thus, energy for breaking the cable sheath 20d decreases, and breaking of the cable sheath 20d can be prevented.

Since the cable sheath 20d is not broken, the feed light 112 does not leak to the outside of the cable 200C. Consequently, a secondary accident can be prevented.

A cable sheath having a property of allowing at least part of the fluorescence 21b to pass therethrough may be used as the cable sheath 20d. A material having a light transmittance in the wavelength range (visible light range) of the fluorescence 21b may be used as a constituent material of the cable sheath 20d, so that visible light that is at least part of the fluorescence 21b passes through the cable sheath 20d and is emitted to the outside of the cable 200C.

Such a configuration enables emission of the fluorescence 21b to be visually observed from the outside of the cable 200C.

Thus, the damaged portion of the optical fiber 250C can be identified and dealt with quickly.

For example, a system that detects suspicion of a damage of the optical fiber 250C based on a leakage loss of the feed light 112a and reports the suspicion is implemented at the same time. If the appearance of the optical fiber cable 200C for feed-light transmission is inspected in response to the report, the damaged portion of the optical fiber 250C can be identified based on the position of leaking fluorescence.

The optical fiber cable 200C for feed-light transmission described above is used as an optical fiber cable in entirety or part of a section from the power sourcing equipment 110 to the powered device 310. The advantages described above can be obtained in the entire section if the optical fiber cable 200C for feed-light transmission is used in the entirety of the section. On other hand, the optical fiber cable 200C for feed-light transmission may be used limitedly to part of the section, such as a section where the occurrence of a damage of the optical fiber is predicted.

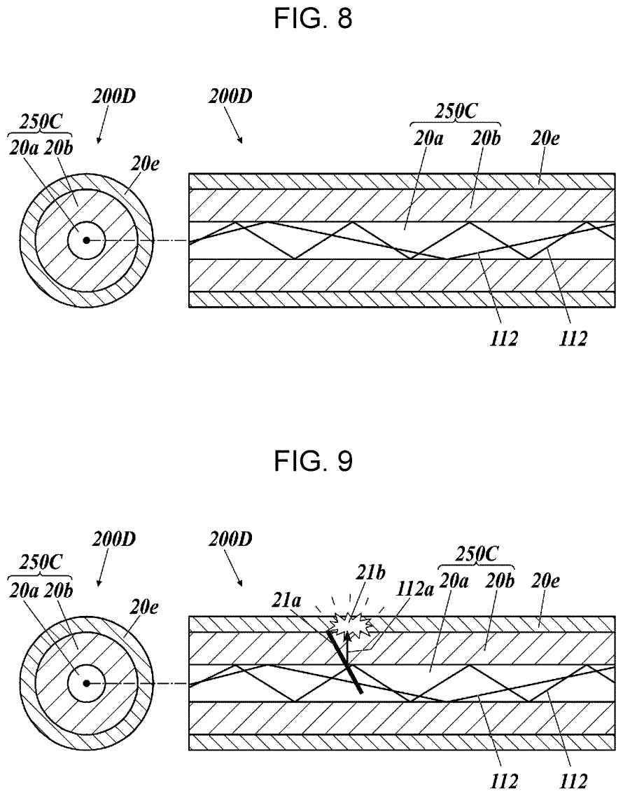

An optical fiber cable 200D for feed-light transmission illustrated in FIG. 8 can be implemented as another configuration.

In the optical fiber cable 200D for feed-light transmission, a cable sheath 20e has a property of emitting fluorescence. The optical fiber cable 200D for feed-light transmission does not include a phospher layer between the cable sheath 20e and the optical fiber 250c. Instead, the cable sheath 20e includes a phospher.

As illustrated in FIG. 8, the optical fiber cable 200D for feed-light transmission includes the optical fiber 250C and the cable sheath 20e. The optical fiber 250C includes a channel of the feed light 112. The cable sheath 20e is located at the periphery of the optical fiber 250C.

As illustrated in FIG. 9, the cable sheath 20e emits fluorescence 20b upon receiving the feed light 112a, and radiates visible light that is at least part of the fluorescence 20b to the outside.

The phospher included in the cable sheath 20e emits the fluorescence 20b, part of which is radiated to the outside the cable 200D. The rest of the configuration is implemented in a manner that is the same as and/or similar to that of the cable 200C described above.

Thus, similarly to the cable 200C illustrated in FIGS. 5 and 6, the optical fiber cable 200D for feed-light transmission can prevent the feed light 112a from breaking the cable sheath 20d even if the optical fiber 250C is damaged and can enable the damaged portion of the optical fiber 250C to be identified based on the position of the leaking fluorescence.

In the optical fiber cables 200C and 200D for feed-light transmission according to the respective embodiments above, even if the high-energy feed light 112a leaks to the outside of the optical fiber 250C because of a damage of the optical fiber 250C, loss and/or dispersion of energy occur(s) through dispersion across the wavelength due to fluorescence emission. Thus, breaking of the cable sheath can be prevented, and leakage of the high-energy light to the outside of the cable can be prevented.

When the optical fiber 250C is not damaged but the optical fiber 250C is bent beyond an allowable bending R (designated based on a material, a fiber diameter, or the like) of the optical fiber 250C, the feed light 112a leaks to the outside of the optical fiber 250C. Specifically, as a result of bending, the fiber shape becomes an angle at which total reflection is no longer achieved. Consequently, the feed light 112a leaks.

However, in the optical fiber cables 200C and 200D for feed-light transmission according to the respective embodiments above, even if the high-energy feed light 112a leaks to the outside of the optical fiber 250C because of a deformation of the optical fiber 250C beyond the allowable range, loss and/or dispersion of energy occur(s) through dispersion across the wavelength due to fluorescence emission. Thus, breaking of the cable sheath can be prevented, and leakage of the high-energy light to the outside of the cable can be prevented.

The portion of the optical fiber 250C deformed beyond the allowable range can be identified based on the position of the fluorescence leaking to the outside of the cable. If the portion deformed beyond the allowable range is returned to the allowable range to make the fluorescence no longer leak, the installation can be completed.

While the embodiments of the present disclosure have been described above, these embodiments are merely presented as examples and can be carried out in various other forms. Each component may be omitted, replaced, or modified within a range not departing from the gist of the invention.

In the embodiments described above, a leakage portion indication function is carried out so that part of fluorescence leaks to the outside of the cable. However, only the function of preventing breaking of the cable may be carried out.

### INDUSTRIAL APPLICABILITY

The present invention can be used for optical power supply.

1. An optical fiber cable for feed-light transmission, comprising:
an optical fiber including a channel of feed light;
a cable sheath located at a periphery of the optical fiber and having a property of shielding the feed light; and
a phosphor layer located between the optical fiber and the cable sheath and configured to emit fluorescence upon receiving the feed light.

2. The optical fiber cable for feed-light transmission according to claim 1, wherein the cable sheath has a property of allowing at least part of the fluorescence emitted by the phosphor layer upon receiving the feed light to pass through the cable sheath.

3. An optical fiber cable for feed-light transmission, comprising:
an optical fiber including a channel of feed light; and
a cable sheath located at a periphery of the optical fiber,
wherein the cable sheath is configured to emit fluorescence upon receiving the feed light and radiate at least part of the fluorescence to outside.

4. The optical fiber cable for feed-light transmission according to claim 1, wherein the feed light is ultraviolet light and the fluorescence is visible light in a band wider than a band of the feed light.

5. A power-over-fiber system comprising:
power sourcing equipment including a semiconductor laser configured to oscillate with electric power to output feed light;
a powered device including a photoelectric conversion element configured to convert the feed light from the power sourcing equipment into electric power; and
an optical fiber cable having one end connectable to the power sourcing equipment and an other end connectable to the powered device and configured to transmit the feed light,
wherein the optical fiber cable includes an optical fiber cable for feed-light transmission in entirety or part of a section from the power sourcing equipment to the powered device, and
wherein the optical fiber cable for feed-light transmission comprises:
an optical fiber including a channel of feed light;
a cable sheath located at a periphery of the optical fiber and having a property of shielding the feed light; and
a phosphor layer located between the optical fiber and the cable sheath and configured to emit fluorescence upon receiving the feed light.

6. The power-over-fiber system according to claim 5, wherein a semiconductor material of a semiconductor region that exhibits a light-electricity conversion effect of the semiconductor laser is a laser medium having a laser wavelength of 500 nm or shorter.

7. The power-over-fiber system according to claim 5, wherein a semiconductor material of a semiconductor region that exhibits a light-electricity conversion effect of the photoelectric conversion element is a laser medium having a laser wavelength of 500 nm or shorter.

8. The power-over-fiber system according to claim 5, wherein the cable sheath has a property of allowing at least part of the fluorescence emitted by the phosphor layer upon receiving the feed light to pass through the cable sheath.

9. The power-over-fiber system according to claim 5, wherein, the feed light is ultraviolet light and the fluorescence is visible light in a band wider than a band of the feed light.

10. The optical fiber cable for feed-light transmission according to claim 3, wherein the feed light is ultraviolet light and the fluorescence is visible light in a band wider than a band of the feed light.
